(19) United States
(12) Patent Application Publication
(10) Pub. No.: US 2004/0205021 A1
(43) Pub. Date: Oct. 14, 2004

(54) Enhanced equipment trust certificate structures

(76) Inventors: Thomas F. Cahill, New York, NY (US); Michael P. Weinmann, Hoboken, NJ (US)

Correspondence Address: KIRKPATRICK & LOCKHART LLP, 535 SMITHFIELD STREET, PITTSBURGH, PA, 15222, US

(21) Appl. No.: 10/857,116

(22) Filed: May 28, 2004

(51) Int. Cl. G06F 17/60

(52) U.S. Cl. 705/38

(57) ABSTRACT

The present invention is directed to EETC structures. In one embodiment, interest on the subordinate class (or classes) of certificates is paid before principal distributions on the senior class of certificates. In addition, the subordinate certificate holders may have the option to buy out senior equipment notes issued under defaulted indentures. Also, the above-cap liquidity facility may be sized only to cover interest amounts due above a capped rate for a shortened time period following an event of default. Following the shortened time period, the interest rates on the certificates may be capped at a fixed rate. In addition, for a time period following an event of default, the controlling party of the collateral may be prohibited from leasing the collateral unless (i) all equipment note payments owed are paid or (ii) the term of the lease is for a relatively short period of time, such as one year, for example. Additionally, following an event of default, a trustee report may be prepared for the benefit of, among others, the certificate holders that contains specific information related to the transaction. These enhancements to the conventional EETC structure have the benefit, among other things, of making the subordinate tranches more attractive to potential investors.

### BACKGROUND

The present invention is directed generally to enhanced equipment trust certificates (EETCs).

Enhanced equipment trust certificates (EETCs) are a form of corporate debt, typically issued by an airline. The debt is secured by a pool of aircraft or related collateral. Due to the value of the collateral and several structural enhancements, EETCs are rated (often significantly) higher that the underlying airline. The depth of the market, the low cost of funding and the structural flexibility of EETCs have made EETCs the financing structure of choice for almost every major U.S. airline. Since their inception in 1994, over $42 billion of EETCs have been issued by U.S. airlines to finance aircraft in their fleet.

U.S. airlines typically use the EETC structure to finance aircraft or related equipment (e.g., spare parts). FIG. 1 is a diagram of a typical EETC structure. The issuing airline 10, in conjunction with a pass through trustee, forms a number of pass through trusts under a separate pass through trust agreement for each pass through trust. In the illustrated embodiment, there are three such pass through trusts 22, 24, 26. Each pass through trust 22, 24, 26 issues a different class of EETC certificate. In the illustrated embodiment, the Class A pass through trust 22 issues Class A certificates, held by the Class A certificate holders 12, the Class B pass through trust 24 issues Class B certificates, held by the Class B certificate holders 14, and the Class C pass through trust 26 issues Class C certificates, held by the Class C certificate holders 16. Each class of EETC certificates represents 100% of the fractional undivided interests in the corresponding pass through trust.

With the proceeds from the sale of the EETC certificates, each pass through trust 22, 24, 26 purchases equipment notes issued by the airline 10 (or owner trust in the case of a leveraged lease) to finance or refinance aircraft in the fleet of the airline 10. The airline 10 issues the equipment notes under a separate indenture for each aircraft. In that regard, the payment obligations of the airline 10 for the aircraft (e.g., lease payments for leased aircraft or mortgage payments for aircraft owned by the airline) are assigned to the indenture trustee 18. Where there are three classes of EETC certificates, as in the example of FIG. 1, the airline 10 issues three classes of equipment notes. The Class A pass through trust 22 purchases and holds the Class A equipment notes 4, the Class B pass through trust 24 purchases and holds the Class B equipment notes 6, and the Class C pass through trust 26 purchases and holds the Class C equipment notes 8. There is a one-to-one correspondence between the principal amount of the equipment notes and the corresponding EETCs for each class.

The pass through trustee and the indenture trustee are different legal entities, but their roles are often performed by the same institution.

The EETC certificates, like most debt instruments, entitle the holder thereof to principal and interest payments. The distributions are typically made semiannually or quarterly, on so-called “distribution dates.” The interest rates can be either fixed or floating. For floating-rate EETCs, the interest rate is usually indexed to a published index rate, such as LIBOR. The different classes (or tranches) of EETC certificates have different priorities with respect to payment distributions. In this example, Class A is ranked above Class B, which is ranked above Class C. The senior certificates (Class A in this example) typically pay the lowest yield and the most subordinate (Class C) pay the highest.

The indenture trustee 18 makes payments received from the airline 10 on the equipment notes to a subordination agent 20. The subordination agent 20 distributes the payments according to a so-called “cash flow waterfall,” or simply “waterfall.” The waterfall is the hierarchical order in which payments on the equipment notes are distributed. In conventional EETC structures, after paying fees and expenses, the subordination agent 20 distributes the funds to the pass through trusts 22, 24, 26 such that the holders of the Class A certificates 12 are paid the principal and interest on the Class A EETCs before the holders of the Class B certificates 14 are paid the principal and interest on the Class B EETCs, which is before the holders of the Class C certificates 16 are paid the principal and interest on the Class C EETCs. Thus, the Class C certificate holders 16 are paid last and, in an event of default by the airline 10 such that not enough funds are available, the Class C certificate holders 16 may experience a shortfall with respect to expected payments. The Class B holders 16 are next-to-last in the waterfall hierarchy and are exposed to the risk that there may not be enough funds to pay the Class B holders 16 after payment of the principal and interest to the Class A holders 12. For this reason, the Class C certificate holders usually require the highest return on investment and the Class A certificate holders the lowest return on investment.

To provide interest coverage to investors in the event of a payment default, the airline 10 typically arranges for a revolving credit facility between the subordination agent 20 as borrower and a primary liquidity provider 28. The liquidity provider 28, in exchange for a fee, agrees to make advances (so-called “interest drawings”) to the subordination agent 20 to cover eighteen months of interest payments only on the EETC certificates in the event the airline 10 fails to make payment in full on the equipment notes.

In addition, for floating-rate EETCs, the structure typically involves an above-cap liquidity provider 30. The above-cap liquidity provider 30 funds an account (the above-cap account 31) to cover interest payments only corresponding to the difference between the floating rate and a specified cap-rate for, for example, eighteen months in the event of default by the airline 10. The primary liquidity provider 28 is responsible for an amount corresponding to the interest payments up to the capped rate. Thus, for example, if the Class A certificates pay LIBOR plus 0.5% and the capped rate is 8.5% (corresponding to a LIBOR cap-rate of 8.0%), but LIBOR is 20.0%, the primary liquidity provider 28 has to fund the liquidity account with sufficient funds to cover 8.5% interest for the Class A certificates for a period of eighteen months. The above-cap liquidity provider 30 funds the above-cap account 31 to cover the remainder of the interest payments (20%−8%=12% interest in this example) for the eighteen-month time period. The same thing applies to the class B and C certificates as well to the extent they are covered by an above-cap liquidity facility.

One reason the EETC structure is appealing to the airline industry pertains to § 1110 of the Bankruptcy Code. Section 1110 provides that within sixty days after a qualifying air carrier files a petition seeking reorganization under Chapter 11 of the U.S. Bankruptcy Code (subject to extension with the consent of creditors), that air carrier must agree to continue to perform its obligations under the relevant aircraft lease or mortgage (a “1110 election”) and cure any defaults, or, at the request of the aircraft financier, return the aircraft to the financier. Accordingly, aircraft financiers, unlike most other lenders or lessors to an entity that has filed Chapter 11 protection, have the assurance that if the airline is not performing its obligations under the relevant financing documents, they may obtain possession of their collateral within a limited period of time. The rights of § 1110 are held by the EETC holders in an EETC financing. Thus, the EETC holders have the right to obtain possession of the aircraft in order to protect their investment interests. In a typical EETC structure, the holders of the Class A certificates control the collateral, but holders of a subordinate tranche (e.g., Class B or C) have the option to obtain control by buying out the holders of the superior tranches. In order to do so, the holders of the subordinate tranche must buy out the entirety of the holders of the superior tranche(s).

Despite the attractive bankruptcy treatment of the EETC structure for the airline industry, the risks to subordinate debt holders (e.g., the Class B and Class C certificate holders) remain elevated, especially in today's market climate where several major U.S. airlines have either filed for bankruptcy or may do so soon, while still others suffer negative cash burns at unsustainable rates. Accordingly, enhancements to the typical EETC structure are sought that may increase the attractiveness of the subordinate EETCs.

### SUMMARY

In one general aspect, the present invention is directed to an EETC structure. According to various embodiments of the new EETC structure, interest on the subordinate class (or classes) of certificates is paid before principal distributions on the senior class of certificates. According to other variations, the subordinate certificate holders have the option to buy out senior equipment notes issued under defaulted indentures. In that way, for example, the subordinate certificate holders may become a controlling party of an aircraft following a payment default by an airline, rather than having to buy-out all of the senior certificates, as in past EETC offerings.

In addition, according to other variations, the above-cap liquidity facility is sized only to cover interest amounts due above a capped rate for a shortened time period following an event of default. Following the shortened time period, the interest rates on the certificates are capped at a fixed rate. In addition, for a time period following an event of default, the controlling party of the collateral may be prohibited from leasing the collateral unless (i) all expected equipment note payments are covered or (ii) the term of the lease is for a relatively short period of time, such as one year, for example. Additionally, following an event of default, a trustee report may be prepared for the benefit of, among others, the certificate holders that contains specific information related to the transaction.

These and other enhancements to the conventional EETC structure described herein may have the benefit, among other things, of making the subordinate tranches more attractive to potential investors. This and other benefits will be apparent from the description below.

### DESCRIPTION OF THE FIGURES

Embodiments of the present invention are described by way of example in conjunction with the following figures, wherein:

FIGS. 1 and 2 are diagrams of EETC structures; and

FIGS. 3 and 4 are diagrams of the cash flow waterfall according to various embodiments of the present invention.

### DESCRIPTION

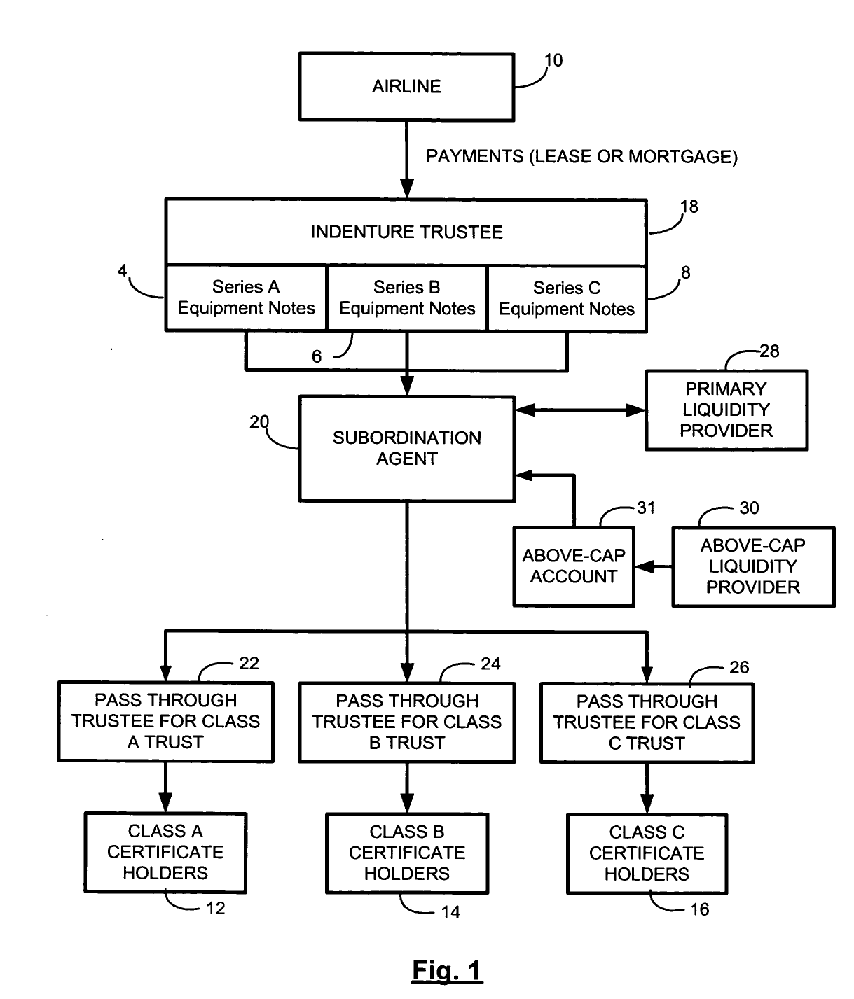

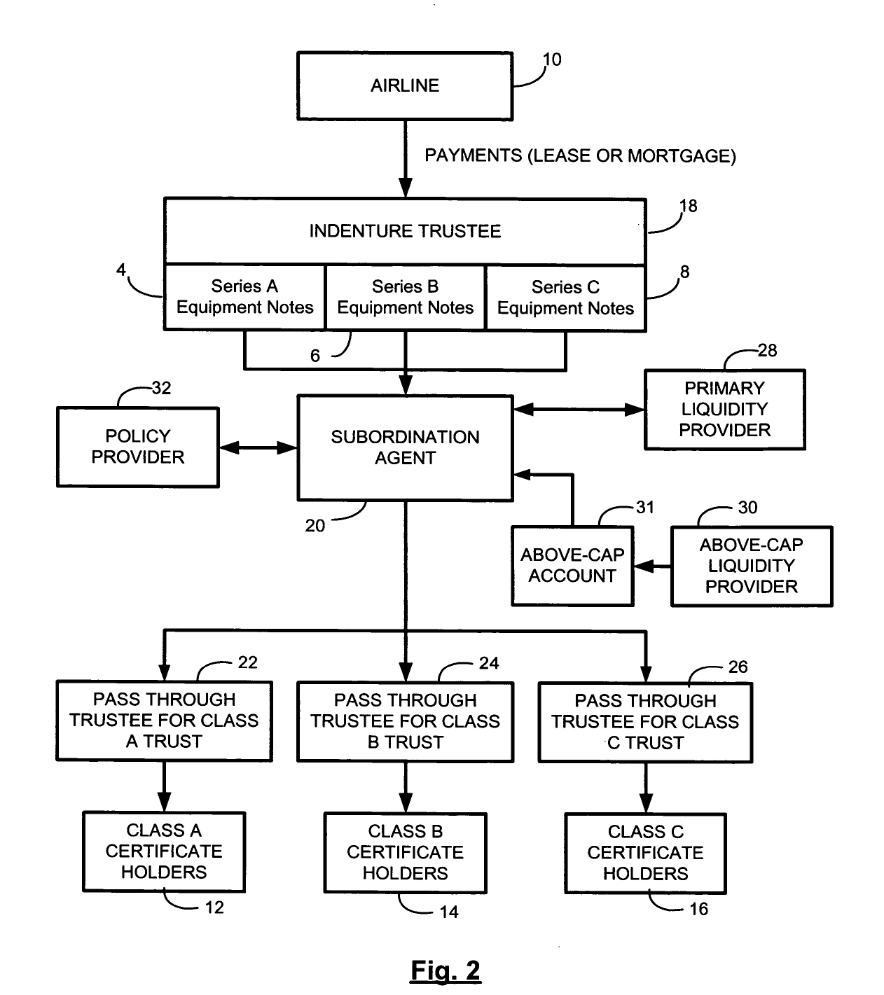

Various embodiments of the present invention are directed to an EETC structure in which interest payments are distributed to subordinate tranche (or certificate class) holders before principal payments are distributed to senior tranche holders. FIG. 2 is a diagram of the EETC structure according to various embodiments of the present invention. The EETC structure of FIG. 2 is similar to that of FIG. 1. The EETC structure may include at least two tranches or classes of certificates. Three tranches (Classes A, B and C) are shown in FIG. 2. For purposes of the discussion to follow, Class A is senior to Class B, which is senior to Class C.

The EETC structure of the present invention may be used, for example, by an airline to finance aircraft in its fleet. The financing may cover multiple aircraft. The debt instruments issued by the airline 10, in conjunction with the pass through trusts 22, 24, 26, may comprise EETCs that pay principal and an interest rate (either fixed or floating) to the holders thereof. For floating-rate EETCs, the interest rate for the certificates may be linked, for example, to an index rate, such as LIBOR. The most senior class of EETCs (for example, the Class A certificates) may pay, for example, LIBOR plus 0.50%. Subordinate certificates may pay greater floating rates, such as, for example, LIBOR plus 2.50% for Class B, and LIBOR plus 4.50% for Class C. The certificates may be, for example, of the bullet maturity type (i.e., entire principal paid at expected maturity date) and/or the amortizing type (partial principal payments made throughout term of the certificates). Further, one or more classes of certificates may have a number of series of certificates that are of a different type (sub-classes). For example, the Class A certificates may have a first series that comprise amortizing notes and a second series that comprises bullet maturity notes. Both series are senior to the Class B and Class C certificates. In a similar way, the Class B and Class C certificates may comprise multiple series of certificates of different types.

According to other embodiments, instead of an airline, other entities such as a manufacturer or insurance company, for example, may use the EETC structure to, for example, manage exposure to an airline or with respect to aircraft or other equipment. Also, the entity issuing the EETC may be an owner trust, such as in a leverage lease financing.

An additional party shown in FIG. 2 is a policy provider 32. The policy provider 32, as explained in more detail below, may enter into an agreement with the subordination agent 20 to guarantee the principal and interest of the senior certificate holders, for example.

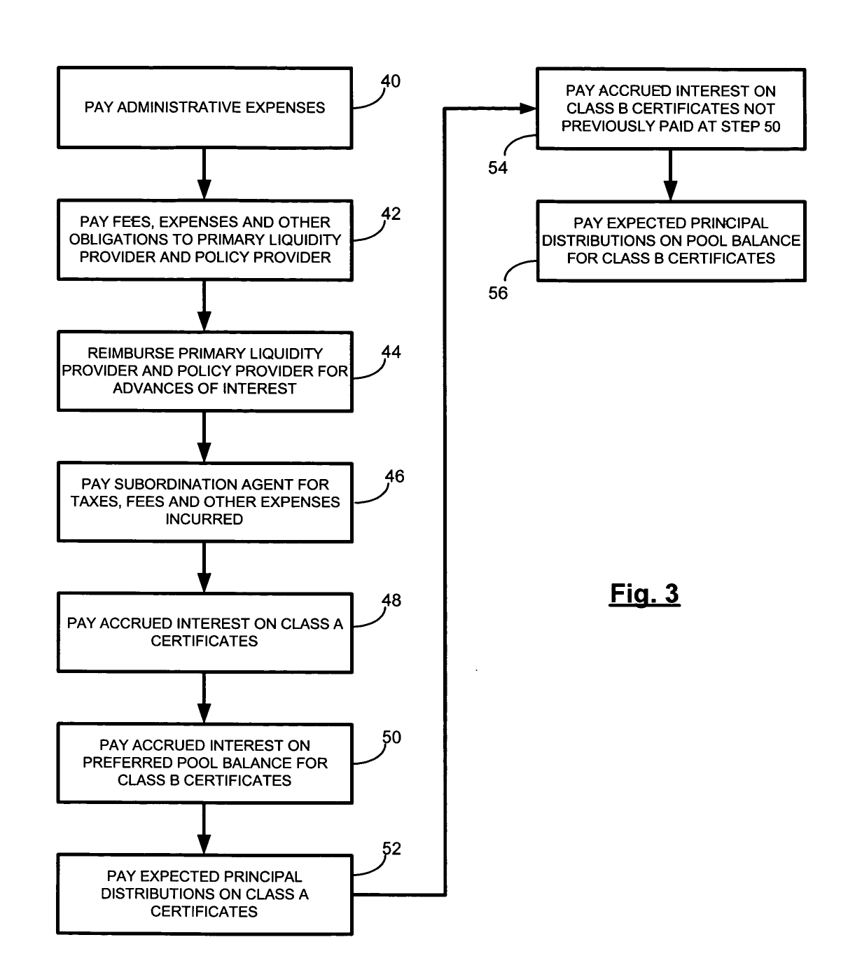

FIG. 3 is a diagram of the cash flow waterfall for the EETC structure according to various embodiments of the present invention, which is different than for past EETC offerings because interest is paid to subordinate certificate holders before principal is paid to senior certificate holders. In the embodiment of FIG. 3, the EETC structure contains two tranches—senior Class A and subordinate Class B. In other variations of the present invention, the cash flow waterfall of FIG. 3 can be extended to three or more tranches, as explained further below.

The cash flow waterfall indicates the priority of distributions by the subordination agent 20 for payments made on the equipment notes. As can be seen in FIG. 3, at step 40, administrative expenses, including funding of an account to pay for appraisals of the aircraft, are paid first. The appraisals may be required, as explained in more detail below, in the event of a payment default with respect to any of the indentures. The subordination agent 20 may, in such circumstances, obtain appraisals on (i) the current market value of the aircraft subject to the indenture, (ii) the current lease rate of the aircraft, and (iii) the distress value of the aircraft. The subordination agent 20 may be obligated to obtain such appraisals at some specific frequency (e.g., yearly) for as long as the default continues.

Next, at step 42, certain fees, expenses and other obligations owing to the primary liquidity provider 28 and the policy provider 32 are paid. Next, at step 44, the primary liquidity provider 28 and the policy provider 32 may be reimbursed for advances of interest. Then, at step 46, taxes, fees or other expenses incurred by the subordination agent 20, the trustees or any certificate holder are paid. Next, at step 48, the accrued and unpaid interest on the Class A certificates is paid to the holders thereof, via the Class A pass through trust 22. These later four steps (steps 42-48) are generally the same as for conventional EETC structures.

Next, at step 50, unlike conventional EETC structures, the interest on a specific portion of the pool balance (the “preferred pool balance”) for the subordinate Class B tranche is paid to the holders of the Class B certificates, via the Class B pass through trust 24. The pool balance generally corresponds, for example, to the original aggregate face amount of the certificates for the pass through trust (the Class B pass through trust 24 in this case) less the aggregate amount of all payments made in respect of the certificates of the trust or in respect of deposits relating to the trust other than payments made in respect of, for example, interest thereon or reimbursement of any costs and expenses in connection therewith. The preferred pool balance may correspond to, as of any date, the excess of (A) the pool balance as of the immediately preceding distribution date (or, if such date is on or before the first distribution date, the original aggregate face amount of the certificates)(after giving effect to distributions made on such date) over (B) (i) the outstanding principal amount of each corresponding equipment note which remains unpaid as of such date subsequent to the disposition of the collateral, (ii) the outstanding principal amount of each corresponding equipment note which remains unpaid as of such date subsequent to the scheduled date of mandatory redemption of such equipment note following an event of loss with respect to the collateral (e.g., aircraft) which secured the note, (iii) the difference between (x) the outstanding amount of principal and interest as of the date of sale of each equipment note previously sold and (y) the purchase price received with respect to the sale of such equipment note and (iv) the amount of principal outstanding on any corresponding equipment note with respect to which a disposition event has not occurred for, for example, five years after the occurrence of the relevant indenture event of default. An example of a preferred pool balance calculation is provided below.

Next, at step 52, the expected principal distributions of the pool balance for the Class A certificates are paid to the holder of the Class A certificates. Next, at step 54, the remaining accrued and unpaid interest not previously paid at step 50 is paid to the Class B certificate holders 14. Then, at step 56, the expected principal distributions of the pool balance for the Class B certificates are paid to the holder of the Class B certificates. Thus, unlike prior EETC structures, the cash flow waterfall for various embodiments of the present invention pays the interest to the subordinate tranches before paying the principal distributions to the senior tranches. This may have the effect of the making the EETC offering by the airline 10 more attractive to the subordinate tranche investors.

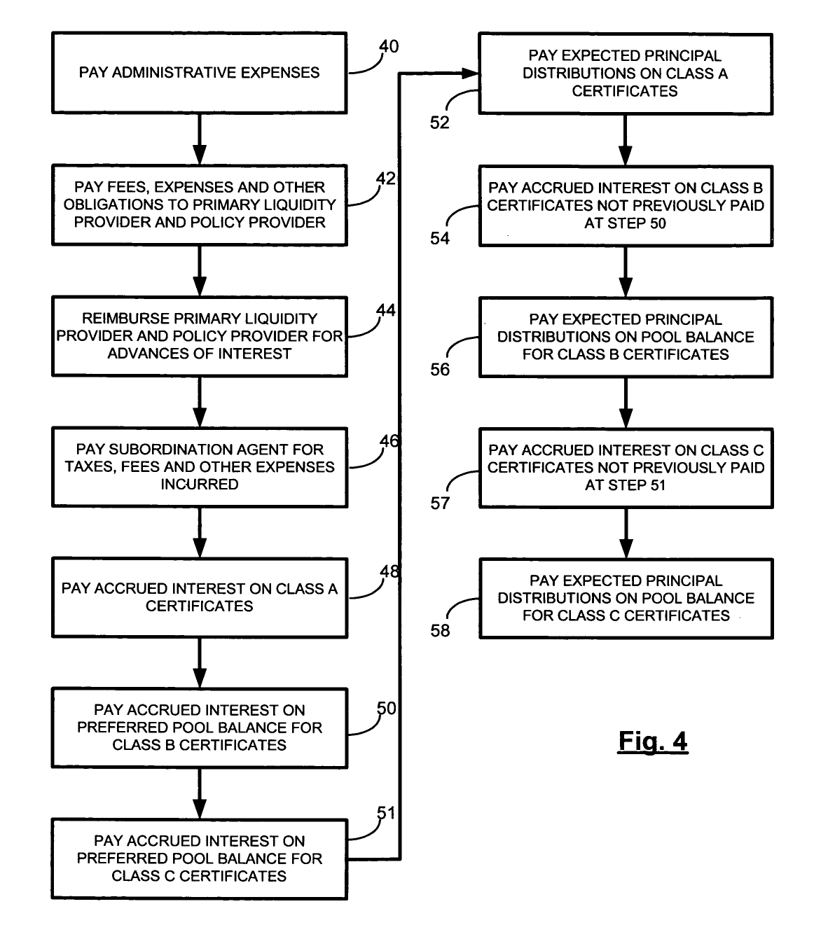

The cash flow waterfall in which subordinate certificate holders are paid interest prior to principal being paid to more senior note holders may be extended to EETC structures having more than two classes or tranches, as shown in FIG. 4, which shows the cash flow waterfall for an EETC structure having three EETC classes pursuant to various embodiments of the present invention. The waterfall of FIG. 4 is similar to that of FIG. 3, except that at step 51, after step 50, the accrued and unpaid interest on the preferred pool balance for the Class C certificates is paid to the holders of the Class C certificates. Also, at step 57, after step 56, the accrued and unpaid interest on the Class C certificates not previously paid at step 51 is paid. Further, at step 58, the expected principal distributions of the pool balance for the Class C certificates are paid to the holder of the Class C certificates.

The following is an example of a calculation of the preferred pool balance. Suppose, for purposes of this example, that the EETC structure has two classes of certificates, senior Class A and subordinate Class B. Further assume that the financing covers ten aircraft with the Class A notes being $20 for each aircraft and the Class B notes being $10 for each aircraft. In that case, the pool balance for Class B would be $100 (computed as $10 for each aircraft times ten aircraft). If, for example, due to default, one of the aircraft were sold for $25, then the preferred pool balance for Class B would be reduced to $90. This is because, of the $25 recovered for sale of the aircraft, $20 is allocated to the Class A note and the remaining $5 to the Class B note (to be paid to the Class B certificate holders). Thus, the Class B preferred pool balance would recognize a $5 shortfall. The $5 from the sale proceeds and the $5 from the loss results in the preferred pool balance being reduced to $90. The remaining $90 (corresponding to nine unsold aircraft at $10 per note for aircraft for Class B) would still be included in the preferred pool balance until, for example, either (i) a previously unsold aircraft subject to the financing is sold or (ii) five years passes after default.

Returning to FIG. 1, the policy provider 32 may, for example, unconditionally and irrevocably honor drawings to cover any shortfall on any distribution date in interest on the senior Class A certificates, as applicable, and any shortfall of the final distribution amount on the final distribution date of the Class A certificates. Further, upon a default in the payment of principal on the Class A notes, or if the Class A notes are accelerated, the policy holder 32 may pay the outstanding amount of principal and accrued interest on the defaulted Class A note at some point in time (e.g., 21 months) after the last distribution date on which full payment on the defaulted Class A note was made prior to such default. Alternatively, if a defaulted Class A note or any underlying collateral is disposed of in connection with the exercise of remedies, not including the exercise of a buy-out option by holders of a subordinate tranche of certificates, the policy provider 32 may pay, after giving effect to the application of disposition proceeds, the amount, if any, required to reduce the pool balance of the related Class A certificates by an amount equal to the outstanding principal amount of such defaulted Class A notes plus accrued and unpaid interest on the amount of such reduction.

In past EETC structures, as mentioned previously, subordinate tranche holders typically have the option to buy out an entire class of more senior tranche holders (a “certificate-level buy-out right”). This may be a valuable right in situations of bankruptcy of the airline because then, under § 1110 of the Bankruptcy Code, the subordinate tranche holders could replace the more senior tranche holders as controlling party of the collateral, i.e., the fleet of aircraft subject to the financing. In past EETC structures, however, the subordinate tranche holders could only exercise their buy-out rights if they bought out the entire class of senior certificate holders.

According to variations of the present invention, rather than or in addition to the certificate-level buy-out right, the EETC structure provides subordinate EETC holders with an option to buy out the senior equipment notes issued under defaulted aircraft indentures at, for example, par plus accrued interest and possibly other amounts. The payment of principal plus accrued interest may be made to the subordination agent 20, who may then distribute the payments to the Class A certificate holders 12. Consequently, for variations of the present invention, the subordinate EETC holders may become the controlling party for such indenture. Thus, the subordinate EETC holders may become the controlling party for the particular aircraft corresponding to the bought-out equipment notes.

In that regard, according to various embodiments of the present invention, if an event of default under an indenture has occurred and is continuing, during (a) the period commencing upon of the occurrence of such event of default and ending on, for example, the date occurring six months after the earlier of (1) the acceleration of the equipment notes under such indenture or (2) the occurrence of a bankruptcy by the airline and (b) any time after such event of default has occurred and has been continuing for five years without a disposition of the equipment notes issued under such indenture or aircraft subject to such indenture, one or more subordinate EETC certificate holders may have the right to purchase all of the senior equipment notes issued under such indenture. The proceeds from the purchase of the equipment notes may be used to pay the holders of the senior EETC certificates. Upon exercising such buy-out right, the holders of a majority of the principal amount of the senior equipment notes may become the controlling party in respect of such indenture and the related aircraft.

In addition, as mentioned previously, in conventional floating-rate EETC structures the above-cap liquidity provider 30, together with the primary liquidity provider 28, covers, for example, eighteen months of the floating rate interest on the EETC certificates. Typically, the primary liquidity provider 28 is responsible for the interest payments up to a cap-rate and the above-cap liquidity provider 30 is responsible for the difference between the floating rate and the cap-rate.

According to variations of the present invention, the above-cap liquidity provider 30 may sufficiently find the above-cap account 31 to cover the difference in the floating rate and the cap-rate for a period of time following a default corresponding to, for example, the shorter of the cure of the default and three months. Following this time period, interest rates for the EETCs are capped at the cap-rate, thereby eliminating the need for an extended above-cap funding period. For example, if the cap-rate is LIBOR=8.0% and the interest rate on the Class A certificates is LIBOR+0.5%, and if at default LIBOR=20%, then the above-cap liquidity provider 30 may fund the above-cap account 31 with sufficient funds cover three months of interest payments on the difference between 20.5% and 8.5% (or 12.0%) for the Class A certificates, assuming the default was not cured during the three months. After the three months, the interest rate on the EETCs is capped at the cap-rate. Thus, the obligations of the above-cap liquidity provider 30 would end after the three months (unless the default is cured and another default occurs subsequently).

The above-cap liquidity provider 30 may enter into separate irrevocable interest rate cap agreements (“above-cap liquidity facilities”) with the subordination agent 20 with respect to each class, or each series of each class, of EETC certificate. Under each above-cap liquidity facility, the above-cap liquidity provider 30 is obligated to make payments on any distribution date if (i) the subordination agent 20 does not have sufficient funds for the payment of interest on any of the EETC certificates, and (ii) the floating interest rate on the EETC certificates exceeds the cap-rate for the respective certificate classes. The amount of the payment may correspond to (a) the difference in the floating interest rate minus the cap-rate for the respective certificate classes, multiplied by (b) the pool balance for each class as of the distribution date, times (c) the specific time period.

In typical EETC offerings secured by mortgaged aircraft, in the event of bankruptcy by the airline, there is no limitation on the right of the party in control of the collateral (e.g., the aircraft) to lease the aircraft. As a consequence, in some instances the controlling party, i.e., the senior tranche holders, leased the collateral aircraft at rates that only covered the interest and principal on the senior tranche certificates, to the detriment of the subordinate tranche holders. In order to provide some protection to the subordinate tranche holders, in some prior EETC offerings the controlling party was prevented from adjusting leases on leased aircraft in the nine months following bankruptcy or acceleration of the equipment notes if the adjustment resulted in more than a 25% discount to the present value of the contracted lease payments.

In order to further enhance the protection of the subordinate tranche holders, according to various embodiments of the present invention, during a time period (e.g., nine months) following a declaration of bankruptcy by the airline or acceleration of the equipment notes, (or other default event) the controlling party may not lease the aircraft unless (i) all related equipment note payments are covered by the contracted lease payments or (ii) the term of the lease does not exceed a relatively short time period, such as one year.

In typical EETC structures, updated appraisals of the collateral aircraft are only required in the event that the airline 10 does not perform on any equipment note and if the airline is in bankruptcy. In contrast, according to variations of the present invention, the trustee or the subordination agent 20 is required, upon default, to obtain a number of appraisals (e.g., three) for the current market value of the aircraft, current lease rates for the aircraft, and distress values for the aircraft, on a regular basis (such as annually or semi-annually). Payments for the appraisals may be made prior to the distribution of interest and/or principal to the EETC certificate holders, as described above in connection with FIG. 3.

In addition, according to other variations of the present invention, upon a default triggering event, the trustee or subordination agent 20 may be required to prepare a statement for the benefit of the EETC certificate holders or others. The statement may contain, for example, the following information, to the extent the information is known and available to the trustee or subordination agent 20: (1) Section 1110 status of the aircraft; (2) maintenance/operating status of the aircraft; (3) current certificate and equipment note balances and expected accrued interest; (4) details of amounts paid on current payment date; (5) amounts owed to the policy provider and liquidity providers; (6) operational reports from the airline; (7) most recent post-default appraisals; and (8) upcoming priority expenses in cash flow waterfall (e.g., see steps 40-46 of FIG. 3).

The equipment notes are issued with respect to each aircraft subject to the financing, and may be issued under a separate indenture between the airline 10 and the indenture trustee 18. If an event of loss occurs with respect to any aircraft and such aircraft is not replaced by the airline 10 under the related indenture, the equipment notes issued with respect to such aircraft may be redeemed, in whole, at a price equal to the aggregate unpaid principal balance amount thereof, together with accrued interest thereon to, but not including, the date of redemption, and other amounts payable to the holders of the equipment notes under the indenture. All of the equipment notes issued with respect to any aircraft may be redeemed prior to maturity at any time at the option of the airline, at a price equal to the aggregate unpaid principal thereof, together with accrued interest thereon to, but not including, the date of redemption, plus any other amounts payable on the equipment notes.

The equipment notes issued with respect to each aircraft may be secured, for example, by (i) a mortgage in favor of the indenture trustee 18 of such aircraft and (ii) an assignment to the indenture trustee 18 of certain of the airline's rights under its purchase agreement with the aircraft manufacturer. The obligations under each indenture may be cross-collateralized as each indenture may secure all amounts owing under all the indentures. However, the only cross-default in the indentures may occur only if all amounts owing under any equipment note issued under another indenture are not paid in full on or before the final distribution date. Therefore, according to such embodiments, prior to the final distribution date, if the equipment notes issued one or more of the indentures are in default and the equipment notes issued under the remaining indentures are not in default, no remedies will be exercisable under such remaining indentures.

Events of default under each indenture may include, for example: (i) the failure of the airline to pay any interest and principal, or any other amounts due, when due under such indenture or under any equipment note issued thereunder that continues for more than, for example, ten business days; (ii) any representation or warranty made by the airline in such indenture or other related legal document being untrue or inaccurate in any material respect when made that continues to be material and remains unremedied after notice and specified cure periods; (iii) the failure by the airline to perform or observe in any material respect any covenant obligation for the benefit of the indenture trustee or holders of the equipment notes under such indenture or related legal documents that continues after notice and specified cure periods; (iv) the lapse or cancellation of insurance required under the indenture; (v) the occurrence of certain events of bankruptcy, reorganization or insolvency by the airline; or (vi) in any amounts secured by any other indenture that are due and payable on or before the final distribution date have not been paid in full on or before such date. The holders of a majority in principal amount of the outstanding equipment notes issued with respect to any aircraft, by notice to the indenture trustee 18, may on behalf of all holders waive any existing default and its consequence under the indenture with respect to such aircraft, except that, according to various embodiments, a default in the payment of principal or interest on any such equipment note, or any other amounts owed with respect to the equipment note, cannot be waived without the consent of each holder of the equipment notes affected thereby.

The parties participating in the EETC offering, e.g., the airline 10, the indenture trustee 18, the pass through trustees, the subordination agent 20, the liquidity providers 28, 30, and the policy provider 32, may enter into a contractual agreement, sometimes referred to as an “intercreditor agreement.” The intercreditor agreement may stipulate many of the EETC features mentioned above, such as, for example, the cash flow waterfall provisions, the buy-out rights of subordinate certificate holders, the above-cap floating interest rate payment provisions, the limitations on leasing aircraft following an event of default, the reporting provisions, etc. The parties participating in the EETC offering, as signatories to the intercreditor agreement, would, therefore, be contractually bound by its provisions.

The present invention is also directed to, according to various embodiments, the underwriting of the EETC offering or other forms of debt placement (such as a placement agent) for the EETC certificates described above. That is, for example, various embodiments of the present invention are directed to the underwriting of an EETC offering, where the offering includes EETC certificates of at least two classes (e.g., Class A and Class B), where interest on the subordinate class (e.g., Class B) is paid before principal on the senior class (e.g., Class A). In addition, various embodiments of the present invention are directed to underwriting an EETC offering having other EETC enhancements described herein.

While several embodiments of the invention have been described, it should be apparent, however, that various modifications, alterations and adaptations to those embodiments may occur to persons skilled in the art with the attainment of some or all of the advantages of the present invention. For example, although the above-description pertained to an EETC offering by an airline using aircraft as collateral, it should be recognized that features of the present invention may be extended to debt offerings by other types of issuers besides air carriers, and/or with different types of collateral besides aircraft. In addition, according to various other embodiments, the cash flow waterfall may direct that a portion of the interest on the subordinate EETC certificates is paid before principal on the senior EETC certificates. It is therefore intended to cover all such modifications, alterations and adaptations without departing from the scope and spirit of the present invention as defined by the appended claims.

What is claimed is:

1. A method, comprising issuing enhanced equipment trust certificates, wherein the certificates include a senior class and at least one subordinate class, and wherein interest on the subordinate class of certificates is to be distributed before principal on the senior class of certificates is to be distributed.

2. The method of claim 1, wherein the issuing of the enhanced equipment trust certificates is performed by an airline to finance aircraft in the fleet of the airline.

3. The method of claim 1, wherein the issuing of the enhanced equipment trust certificates is performed by an owner trust in a leveraged lease financing.

4. The method of claim 1, wherein:
the certificates include first and second subordinate classes;
interest on the first subordinate class is to be distributed before interest on the second subordinate class is to be distributed; and
interest on the second subordinate class is to be distributed before principal on the senior class of certificates is to be distributed.

5. A method, comprising:
selling a first class of enhanced equipment trust certificates of a first pass through trust;
the first pass through trust purchasing a first class of equipment notes issued by an entity;
selling a second class of enhanced equipment trust certificates of a second pass through trust; and
the second pass through trust purchasing a second class of equipment notes issued by an entity,
wherein the first class of certificates is senior to the second class of certificates, and wherein interest on the second class of certificates is to be distributed before principal on the first class of certificates is to be distributed.

6. The method of claim 5, further comprising:
selling a third class of enhanced equipment trust certificates of a third pass through trust; and
the third pass through trust purchasing a third class of equipment notes issued by an entity,
wherein the second class of certificates is senior to the third class of certificates, and wherein interest on the third class of certificates is to be distributed before principal on the first class of certificates is to be distributed.

7. The method of claim 5, wherein each of the first and second classes of equipment notes are issued under a separate indenture, and wherein holders of the second class of certificates have an option to purchase a first class equipment note issued under a defaulted indenture.

8. The method of claim 7, further comprising a primary liquidity provider and an above-cap liquidity provider entering into a liquidity facility to cover interest payments on the first and second classes of certificates for a period of time following an event of default, and wherein the interest rates on the first and second classes of certificates are capped after the period of time.

9. The method of claim 8, wherein the period of time is three months.

10. The method of claim 8, wherein the first and second classes of certificates are secured by articles of collateral of the entity, and wherein, during a time period following an event of default by the entity, a controlling party of an article of collateral is prohibited from leasing the article unless (i) all expected equipment note payments are covered and (ii) a term of the lease does not extend a specified period of time.

11. The method of claim 10, wherein the entity is an air carrier and the articles of collateral include aircraft.

12. The method of claim 10, further comprising, following the event of default by the entity, obtaining a plurality of appraisals on the collateral.

13. The method of claim 12, wherein expenses related to the appraisals are paid before interest on the first class of certificates is paid.

14. The method of claim 13, further comprising, following the event of default by the entity, preparing a report, wherein the report includes the appraisals.

15. The method of claim 5, further comprising, following an event of default by the entity, preparing a report including information selected from the group consisting of current certificate balances, expected accrued interest on the certificates, current equipment note balances, expected accrued interest on the equipment notes, section 1110 status of the collateral, maintenance status of the collateral, upcoming priority expenses, details of amount paid on current payment date, amounts owed to liquidity providers, amounts owed to a policy provider, and appraisals of the collateral.

16. A method comprising, underwriting an offering of at least first and second classes of enhanced equipment trust certificates by an entity, wherein the first class of certificates is senior to the second class of certificates, wherein interest on the second class of certificates is to be distributed before principal on the first class of certificates is to be distributed, wherein the entity issues at least first and second classes of equipment notes, and wherein each equipment note is secured by an article of collateral of the entity.

17. The method of claim 16, wherein the offering includes a third class of enhanced equipment trust certificates, and wherein the second class of certificates is senior to the third class of certificates, and wherein interest on the third class of certificates is to be distributed before principal on the first class of certificates is to be distributed.

18. The method of claim 16, wherein each of the first and second classes of equipment notes are issued under a separate indenture, and wherein holders of the second class of certificates have an option to purchase a first class equipment note issued under a defaulted indenture.

19. The method of claim 18, wherein interest rates on the first and second classes of certificates are capped after a period of time following an event of default by the entity.

20. The method of claim 19, wherein, during a time period following an event of default by the entity, a controlling party of an article of collateral is prohibited from leasing the article unless (i) all expected equipment note payments are covered and (ii) a term of the lease does not extend a specified period of time.

21. The method of claim 20, wherein, following the event of default by the entity, a plurality of appraisals on the collateral are obtained.

22. The method of claim 21, wherein expenses related to the appraisals are paid before interest on the first class of certificates is paid.

23. The method of claim 22, wherein, following the event of default by the entity, a report is prepared, wherein the report includes the appraisals.

24. The method of claim 16, wherein, following an event of default by the entity, a report is prepared including information selected from the group consisting of current certificate balances, expected accrued interest on the certificates, current equipment note balances, expected accrued interest on the equipment notes, section 1110 status of the collateral, maintenance status of the collateral, upcoming priority expenses, details of amount paid on current payment date, amounts owed to liquidity providers, amounts owed to a policy provider, and appraisals of the collateral.

25. A structure for offering enhanced equipment trust certificates, comprising:
an entity for offering at least first and second classes of enhanced equipment trust certificates, wherein the first class is senior to the second class;
a first pass through trust for holding a first class of equipment notes issued by the entity;
a second pass through trust for holding a second class of equipment notes issued by the entity; and
a subordination agent for distributing payments by the entity on the first and second classes of equipment notes, wherein interest payments on the second class certificates are paid by the subordination agent before principal payments on the first class of certificates.

26. The structure of claim 25, wherein the entity is further for offering a third class of enhanced equipment trust certificates, wherein the second class of certificates is senior to the third class of certificates, and further comprising a third pass through trust for holding a third class of equipment notes issued by the entity, and wherein the subordination agent is further for distributing payments by the entity on the third class of equipment notes, and wherein interest payments on the third class of certificates are to be paid before principal payments on the first class of certificates.

27. The structure of claim 25, wherein the entity is an air carrier, and the first and second classes of certificates are secured by aircraft of the air carrier.

28. The structure of claim 25, wherein the entity is an owner trust in a leveraged lease financing.

29. The structure of claim 25, wherein each of the first and second classes of equipment notes are issued under a separate indenture, and wherein holders of the second class of certificates have an option to purchase a first class equipment note issued under a defaulted indenture.

30. The structure of claim 25, wherein interest rates on the first and second classes of certificates are capped after a period of time following an event of default by the entity.

31. The method of claim 25, wherein, during a time period following an event of default by the entity, a controlling party of an article of collateral is prohibited from leasing the article unless (i) all expected equipment note payments are covered and (ii) a term of the lease does not extend a specified period of time.

32. A method, comprising:
selling a first class of enhanced equipment trust certificates of a first pass through trust;
the first pass through trust purchasing a first class of equipment notes issued by an entity;
selling a second class of enhanced equipment trust certificates of a second pass through trust; and
the second pass through trust purchasing a second class of equipment notes issued by an entity,
wherein the first class of certificates is senior to the second class of certificates, wherein the each of the first and second classes of equipment notes are issued under a separate indenture, and wherein holders of the second class of certificates have an option to purchase a first class equipment note issued under a defaulted indenture.

33. The method of claim 32, further comprising a primary liquidity provider and an above-cap liquidity provider entering into a liquidity facility to cover interest payments on the first and second classes of certificates for a period of time following an event of default, wherein the interest rates on the first and second classes of certificates are capped after the period of time.

34. The method of claim 33, wherein the first and second classes of certificates are secured by articles of collateral of the entity, and wherein, during a time period following an event of default by the entity, a controlling party of an article of collateral is prohibited from leasing the article unless (i) all expected equipment note payments owed are covered and (ii) a term of the lease does not extend a specified period of time.

35. The method of claim 34, further comprising, following the event of default by the entity, obtaining a plurality of appraisals on the collateral, and wherein expenses related to the appraisals are paid before interest on the first class of certificates is paid.

36. The method of claim 35, further comprising, following the event of default by the entity, preparing a report, wherein the report includes the appraisals.

37. The method of claim 32, further comprising, following an event of default by the entity, preparing a report including information selected from the group consisting of current certificate balances, expected accrued interest on the certificates, current equipment note balances, expected accrued interest on the equipment notes, section 1110 status of the collateral, maintenance status of the collateral, upcoming priority expenses, details of amount paid on current payment date, amounts owed to liquidity providers, amounts owed to a policy provider, and appraisals of the collateral.

38. A method, comprising:
selling a first class of enhanced equipment trust certificates of a first pass through trust;
the first pass through trust purchasing a first class of equipment notes issued by an entity;
selling a second class of enhanced equipment trust certificates of a second pass through trust, wherein the first class of certificates is senior to the second class of certificates;
the second pass through trust purchasing a second class of equipment notes issued by an entity; and
a primary liquidity provider and an above-cap liquidity provider entering into a liquidity facility to cover interest payments on the first and second classes of certificates for a period of time following an event of default, wherein the interest rates on the first and second classes of certificates are capped after the period of time.

39. The method of claim 38, wherein the first and second classes of certificates are secured by articles of collateral of the entity, and wherein, during a time period following an event of default by the entity, a controlling party of an article of collateral is prohibited from leasing the article unless (i) all expected equipment note payments owed are covered and (ii) a term of the lease does not extend a specified period of time.

40. The method of claim 39, further comprising, following the event of default by the entity, obtaining a plurality of appraisals on the collateral, and wherein expenses related to the appraisals are paid before interest on the first class of certificates is paid.

41. The method of claim 40, further comprising, following the event of default by the entity, preparing a report, wherein the report includes the appraisals.

42. The method of claim 40, further comprising, following an event of default by the entity, preparing a report including information selected from the group consisting of current certificate balances, expected accrued interest on the certificates, current equipment note balances, expected accrued interest on the equipment notes, section 1110 status of the collateral, maintenance status of the collateral, upcoming priority expenses, details of amount paid on current payment date, amounts owed to liquidity providers, amounts owed to a policy provider, and appraisals of the collateral.

43. A method, comprising:
selling a first class of enhanced equipment trust certificates of a first pass through trust;
the first pass through trust purchasing a first class of equipment notes issued by an entity;
selling a second class of enhanced equipment trust certificates of a second pass through trust, wherein the first class of certificates is senior to the second class of certificates;
the second pass through trust purchasing a second class of equipment notes issued by an entity,
wherein the first and second classes of certificates are secured by articles of collateral of the entity, and wherein, during a time period following an event of default by the entity, a controlling party of an article of collateral is prohibited from leasing the article unless (i) all expected equipment note payments owed are covered and (ii) a term of the lease does not extend a specified period of time.

44. The method of claim 43, further comprising, following the event of default by the entity, obtaining a plurality of appraisals on the collateral, and wherein expenses related to the appraisals are paid before interest on the first class of certificates is paid.

45. The method of claim 44, further comprising, following the event of default by the entity, preparing a report, wherein the report includes the appraisals.

46. The method of claim 44, further comprising, following the event of default by the entity, preparing a report including information selected from the group consisting of current certificate balances, expected accrued interest on the certificates, current equipment note balances, expected accrued interest on the equipment notes, section 1110 status of the collateral, maintenance status of the collateral, upcoming priority expenses, details of amount paid on current payment date, amounts owed to liquidity providers, amounts owed to a policy provider, and appraisals of the collateral

47. A method, comprising:
selling a first class of enhanced equipment trust certificates of a first pass through trust;
the first pass through trust purchasing a first class of equipment notes issued by an entity;
selling a second class of enhanced equipment trust certificates of a second pass through trust, wherein the first class of certificates is senior to the second class of certificates;
the second pass through trust purchasing a second class of equipment notes issued by an entity; and
following the event of default by the entity, obtaining a plurality of appraisals on the collateral, and wherein expenses related to the appraisals are paid before interest on the first class of certificates is paid.

48. The method of claim 47, further comprising, following the event of default by the entity, preparing a report, wherein the report includes the appraisals.

49. A method, comprising:
selling a first class of enhanced equipment trust certificates of a first pass through trust;
the first pass through trust purchasing a first class of equipment notes issued by an entity;
selling a second class of enhanced equipment trust certificates of a second pass through trust, wherein the first class of certificates is senior to the second class of certificates;
the second pass through trust purchasing a second class of equipment notes issued by an entity; and
following an event of default by the entity, preparing a report including information selected from the group consisting of current certificate balances, expected accrued interest on the certificates, current equipment note balances, expected accrued interest on the equipment notes, section 1110 status of the collateral, maintenance status of the collateral, upcoming priority expenses, details of amount paid on current payment date, amounts owed to liquidity providers, amounts owed to a policy provider, and appraisals of the collateral.

50. A method comprising, acting as a placement agent for at least first and second classes of enhanced equipment trust certificates by an entity, wherein the first class of certificates is senior to the second class of certificates, wherein interest on the second class of certificates is to be distributed before principal on the first class of certificates is to be distributed, wherein the entity issues at least first and second classes of equipment notes, and wherein each equipment note is secured by an article of collateral of the entity.
